(19) United States
(12) Patent Application Publication
(10) Pub. No.: US 2014/0089240 A1
(43) Pub. Date: Mar. 27, 2014

(54) SYSTEMS AND METHODS FOR IDENTIFYING AND DISCOVERING SOCIAL PSYCHOGRAPHICS AND DNA

(71) Applicant: REUNIFY LLC, Los Angeles, CA (US)

(72) Inventor: Jafar Adibi, Los Angeles, CA (US)

(73) Assignee: REUNIFY LLC, Los Angeles, CA (US)

(21) Appl. No.: 13/842,939

(22) Filed: Mar. 15, 2013

Related U.S. Application Data
(60) Provisional application No. 61/705,292, filed on Sep. 25, 2012.

(51) Int. Cl. G06N 99/00

(52) U.S. Cl. CPC G06N 99/005
USPC 706/13; 706/12

(57) ABSTRACT

A system, method and computer program product for identifying an entity and characteristics thereof, including identifying an entity and characteristics thereof, wherein the characteristics include as demographics, and psychographics behavior; and identifying the entity and the characteristics thereof based on patterns of social interactions and relations with other entities.

CROSS REFERENCE TO RELATED DOCUMENTS

The present invention claims priority to U.S. Provisional Patent Application Ser. No. 61/705,292 of ADIBI, entitled “SYSTEMS AND METHODS FOR IDENTIFYING AND DISCOVERING SOCIAL PSYCHOGRAPHICS AND DNA,” filed on Sep. 24, 2012, the entire disclosure of which is hereby incorporated by reference herein.

### BACKGROUND OF THE INVENTION

1. Field of the Invention

The present invention relates generally to social media systems and methods, and more particularly to system and methods to identify entities and entities' characteristics via their pattern of social interactions and relations with other entities, and the like.

2. Discussion of the Background

In recent years, social media systems and methods have been developed and continually refined. However, such social media systems and methods have been hindered by various limitations, for example, including limitations related to identifying entities and entities' characteristics via their pattern of social interactions and relations with other entities, and the like.

### SUMMARY OF THE INVENTION

Therefore, there is a need for methods and systems that address the above and other problems with social media systems and methods. Accordingly, the above and other needs are addressed by the illustrative embodiments of the present invention, which provide a novel method and system for identifying entities and entities' characteristics via their pattern of social interactions and relations with other entities, and the like.

Accordingly, in an illustrative aspect, there is provided a system, method and computer program product for identifying an entity and characteristics thereof, including identifying an entity and characteristics thereof, wherein the characteristics include as demographics, and psychographics behavior; and identifying the entity and the characteristics thereof based on patterns of social interactions and relations with other entities.

The system, method and computer program product configured for determining and identifying an accurate description of the entity, the entity including a company, an organization, a place, a time slot event, a state, and a group; and determining and the identifying based on analyzing entities connected to the entity including a social connection, a familial connection, sharing of an attribute or a relationship that can interpret a connection.

The system, method and computer program product configured to extend a concept of DNA in a human body to social media and identifying the entity based on features and attributes defined by interaction of the entity with neighbors and friends.

The system, method and computer program product configured to display and represent the entity with a colored bitmap.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative network graph;

FIG. 2 is illustrative of reducing a size of network by keeping a connection among those who are strongly connected;

FIG. 3 is illustrative of transformation of attributes to values;

FIG. 4 is an illustration of various types of potential relationships among individuals;

FIG. 5 is an illustration of a representation of link weight distribution for a star pattern and from link weight to values;

FIG. 6 is an illustration of an expansion of a star pattern to nodes connected to the star pattern;

FIG. 7 is an illustration of a node connection to the rest of a graph and how each node is connected to every other nodes in the graph;

FIG. 8 is an illustration of a Hilbert Curve used as a policy to make a social DNA sequence;

FIG. 9 is an illustration of a transformation of a graph to social DNA to a bitmap;

FIG. 10 is an illustrative set of features to describe and identify a given node; and

FIG. 11 shows an illustrative example of a computer system that can be used to implement the systems and methods of the present invention.

### DETAILED DESCRIPTION OF THE PREFERRED EMBODIMENTS

To address the above and other problems with social media systems and methods, provided is new and useful systems and methods for determining and identifying a highly accurate description of an entity, whether an individual company, organization, places, time slot event, state, or a group (e.g., social, commercial, other) by analyzing entities connected to such entity. Examples of such connections can include a social connection, a familial connection, and the sharing of similar attributes or any suitable type of relationship that could be used to interpret a connection.

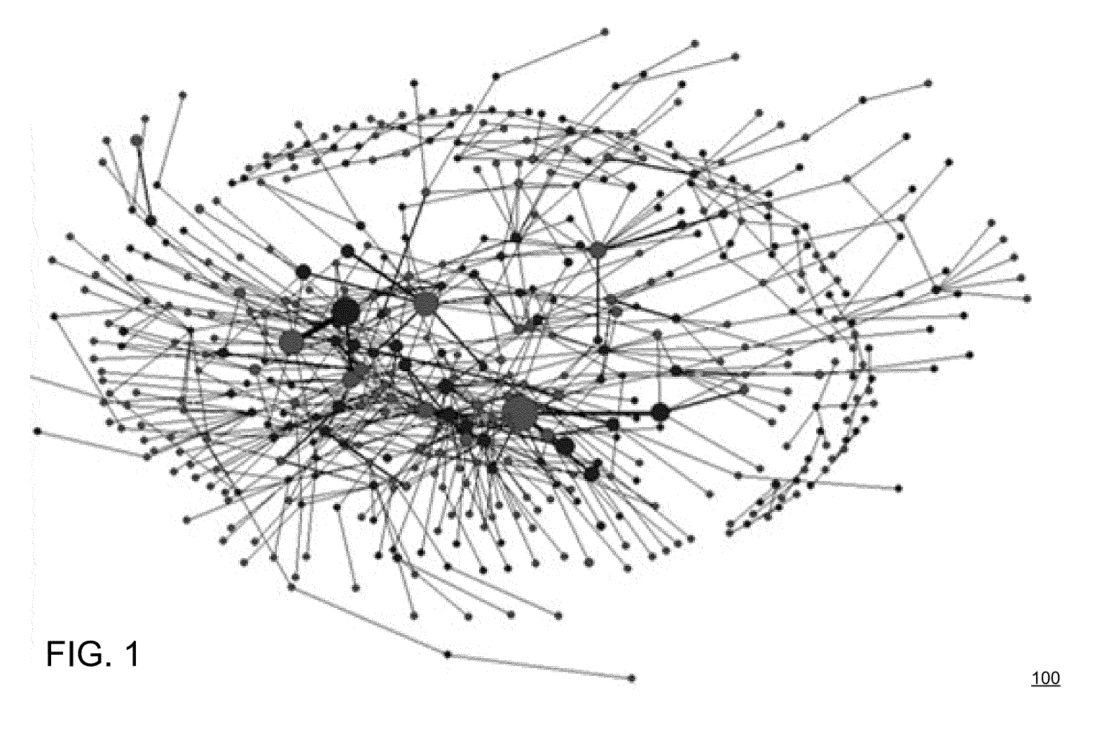

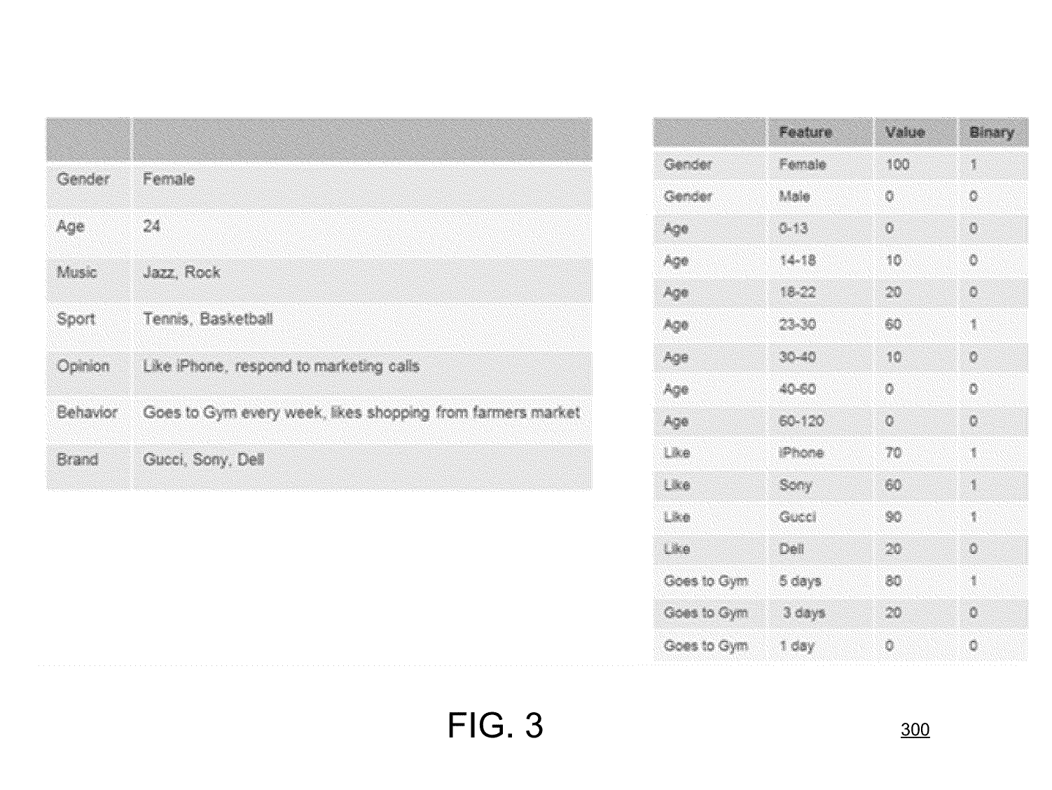

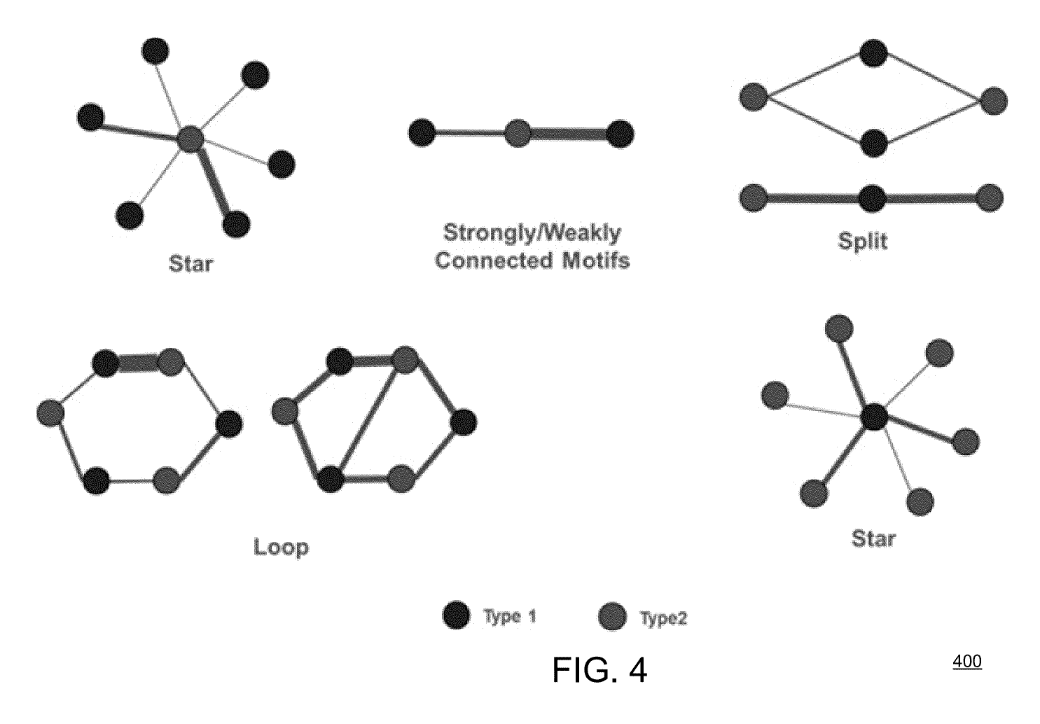

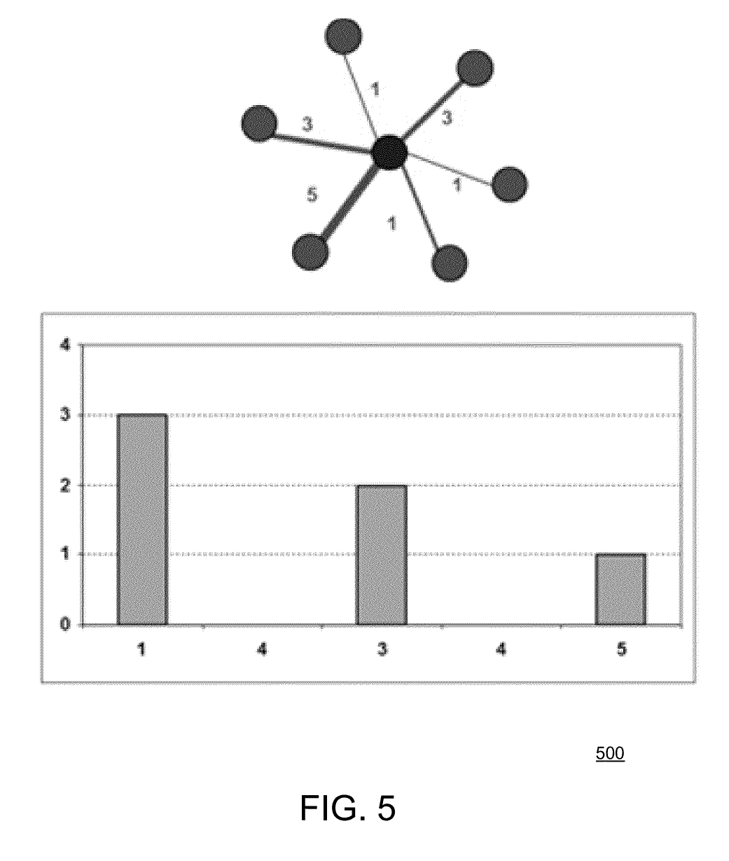

Referring now to the drawings, and FIG. 1 thereof, there is shown an illustrative network or graph, used interchangeably, and the like. In FIG. 1, a network represents a group of an entity (e.g., people) connected to each other through various types of connections, and the like. A good example of such a connection is a social media connection. Each graph include nodes (e.g., entities) and links (e.g., connection between nodes). A graph can have different types of nodes and different types of links. In FIG. 1, the size of network is reduced by keeping the connection among only those who are strongly connected. FIG. 3 is illustrative of transformation of attributes to values. FIG. 4 is an illustration of various types of potential relationships among individuals. FIG. 5 is an illustration of a representation of link weight distribution for a star pattern and from link weight to values.

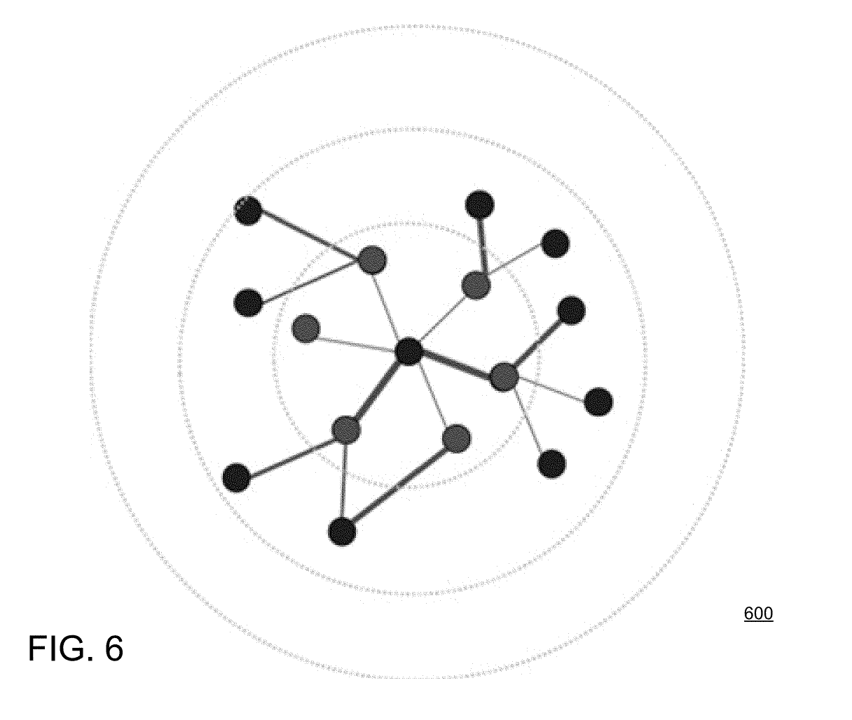

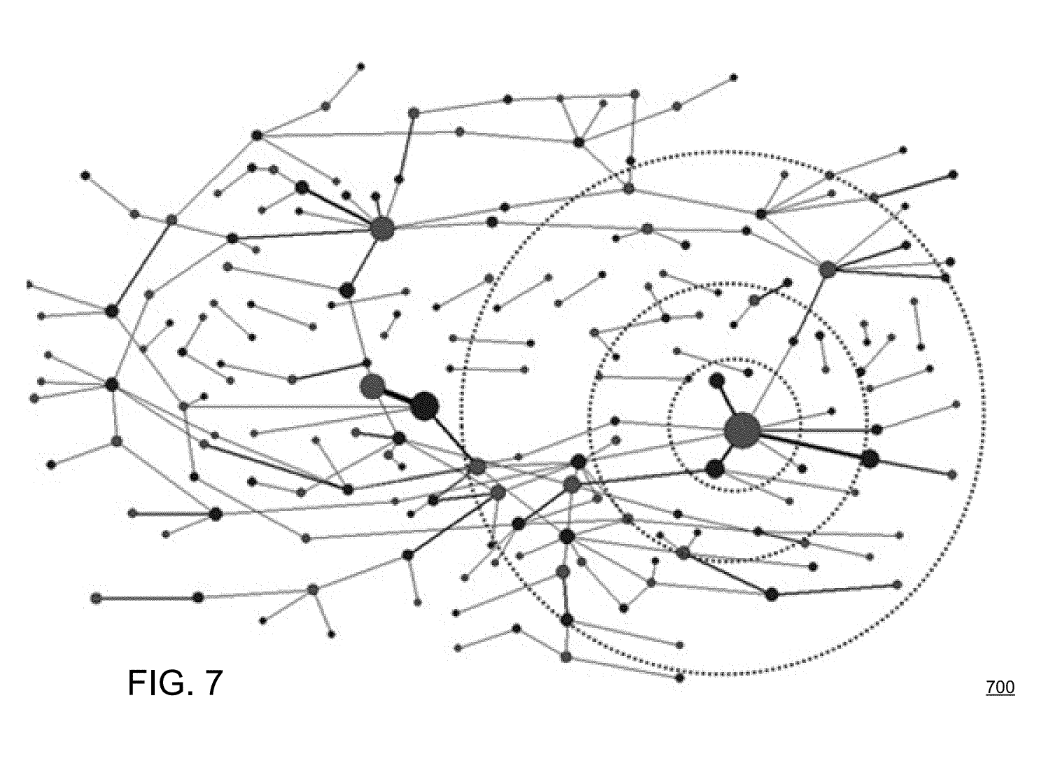

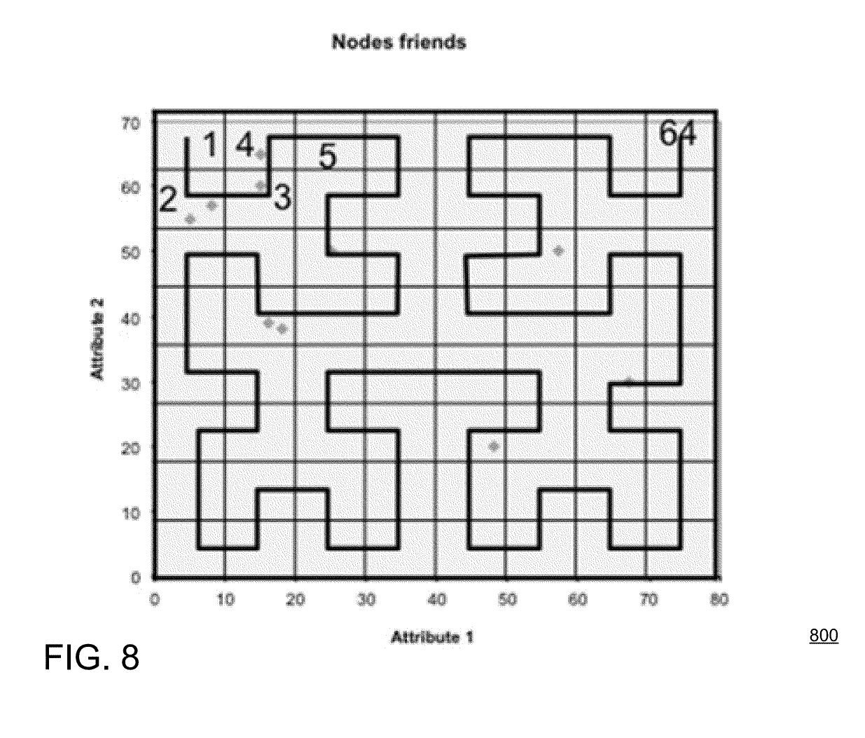

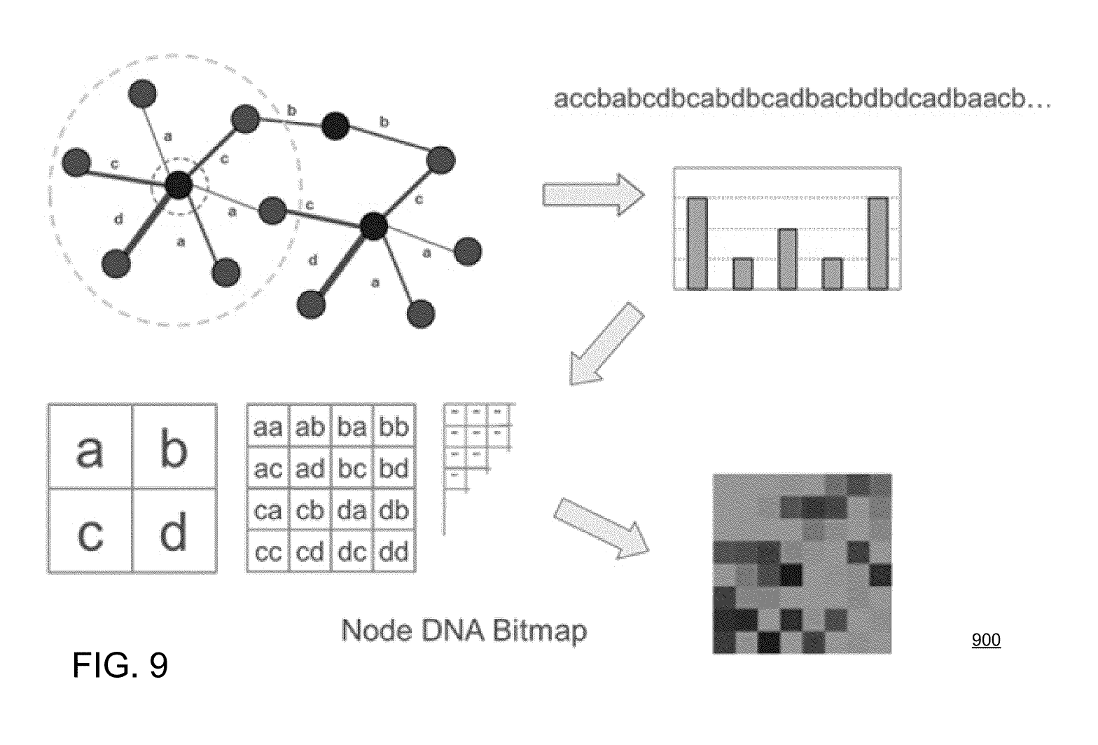

FIG. 6 is an illustration of an expansion of a star pattern to nodes connected to the star pattern. FIG. 6 also illustrates how the system and method can represent a node with all suitable nodes connected to its friends and friend of friends. FIG. 7 is an illustration of a node connection to the rest of a graph and how each node is connected to every other node in the graph. FIG. 8 is an illustration of a Hilbert Curve used as a policy to make a social DNA sequence. FIG. 9 is an illustration of a transformation of a graph to social DNA to a bitmap.

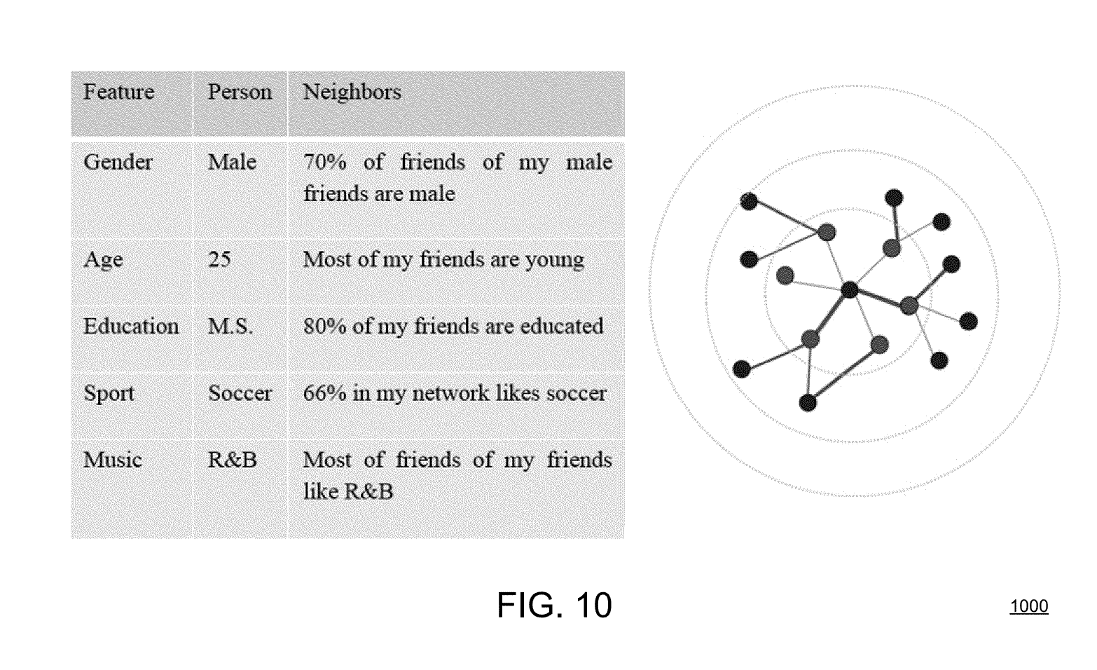

FIG. 10 is an illustrative set of features to describe and identify a given node. In FIG. 10, the graph on the right shows the same person (e.g., the black circle in the center) and her/his friends in a given online social network. The table on the left illustrates a set of features to describe and identify a given person.

In operation, the data of a graph is fed to the system and method. Features are extracted and the distribution of links are calculated. Next, a fixed representation (e.g., Hillbert Space) is selected to calculate the order of features. The final counting of weights is the last step of the process to build the DNA of the node.

DNA is a nucleic acid (e.g., biological molecules) that contains the genetic instructions used in the development and functioning of all known living organisms. DNA governs inheritance of eye and hair color, stature, bone density and many other human traits. Human body cells (e.g., except for a few) contain a complete sample of our DNA identical to that of every other cell within a given person. This means that the human body can be identified by its DNA.

The illustrative systems and methods take the concept of DNA in the human body and extend that to the world of social media. The systems and methods identify an entity such as an organization, a person, a group or a company by its features and attributes defined by its interaction with its neighbors and friends—rather than its own inherent features. For example, the unique social network DNA of a person could be identified by the exciting patterns of his or her relationship with his or her friends connected through an on-line social medium. Advantageously, the illustrative systems and methods employ a unique look-a-like social network DNA for each entity through features of its neighbors (e.g., friends in a social network setup), and neighbors of neighbors, and the like.

In view of numerous disadvantages inherent in the known types of entity identification, and the current definition of social DNA, the present invention provides new systems and methods for identifying an entity by looking deeply at neighbors and neighbors of neighbors, and the like, and employing summaries of information for a unique representation. In this respect, the present invention substantially departs from the conventional concepts and designs of the prior art, and in so doing provides a novel approach to identify a wide verity of entities online. The present invention described herein has no relation to ongoing work, such as GeneTree.com, Geni.com, and Ancestry.com, which try to build “social networks” based on human DNA tests.

To make an entity's Social Network DNA, the system and method represent a distribution of features (e.g., a person's neighbor's education) to a sequence of symbols—similar to DNA, and maps such a representation to a bitmap for classification, clustering and similarity search, and the like. For example, assuming categorization of education to four major categories, including (a) High School, (b) Bachelor, (c) Master, (d) Higher Education (e.g., PhD, MD, JD etc.), the system and method count all suitable sequences of possible combinations of such symbols.

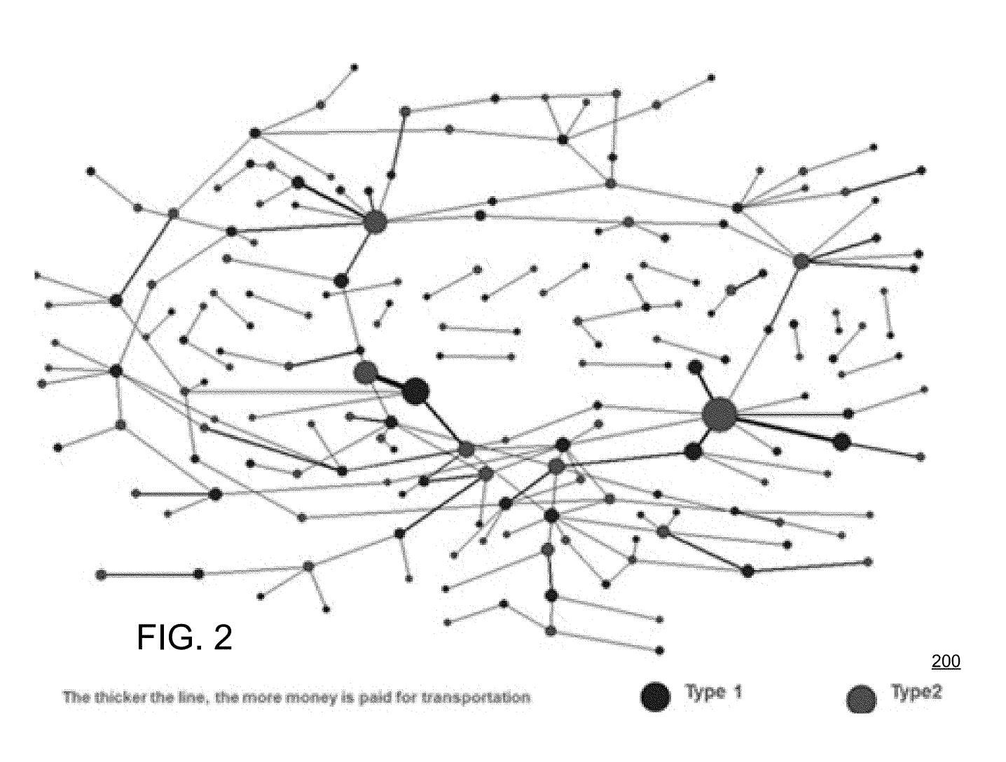

For example, if Count (Bs−Bs−Ms)=8, the means that the system and method do not know the education of the entity x, but there are 8 neighbors with B.S. who have B.S. friends who have M.S. friends. This is done for all suitable attributes to try to map them to bitmaps, for example, as illustrated in FIG. 2. The system and method can normalize the number of counts of each sequence, and pick a color for each cell based on such number. The final bit map represents the entity of interest, whose entire social network is encoded up to certain level (e.g., here we have only considered 3 levels).

The social network DNA of people can change over time, for example, since their friend's interest and their own status might change over time. However, these changes are usually minor considering the fact that the system and method encode all suitable attributes that belong to everybody in an entity's network.

The above described systems and methods can include alternative embodiments and implementations of the engineering and architecture system, for example, using different databases, knowledgebase, tech support systems, client services, and real-time scoring and real-time social monitoring, and the like.

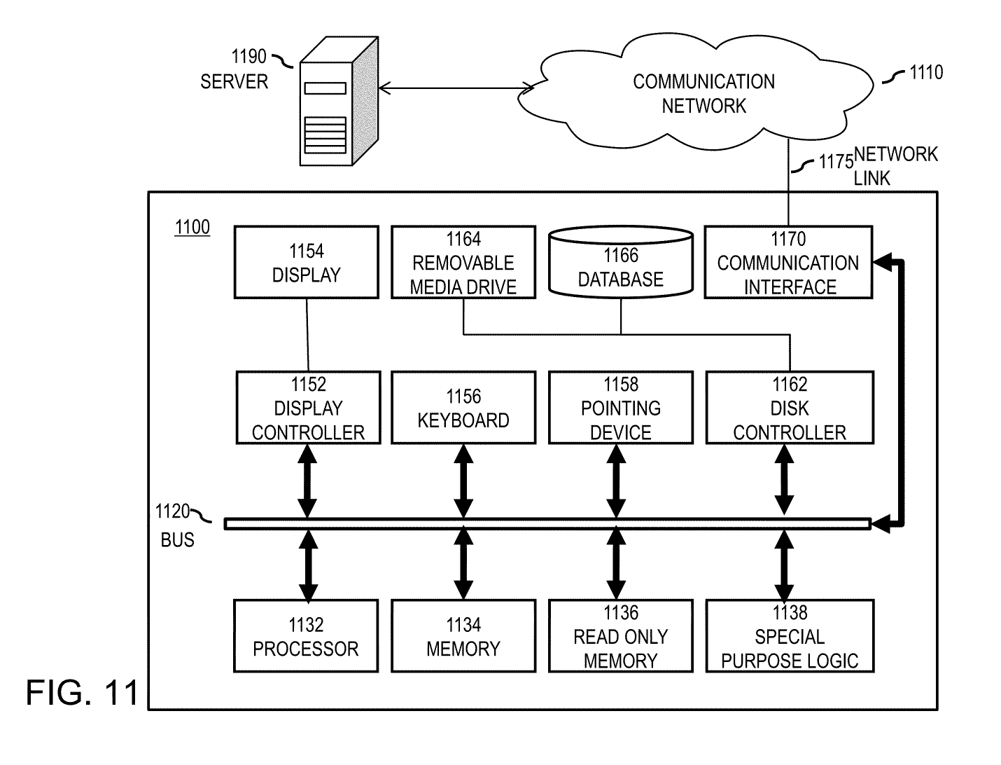

FIG. 11 illustrates a computer system 1100 upon which embodiments of the present invention (e.g., devices and subsystems of the systems and methods of the present invention) can be implemented. The embodiments of the present invention can be implemented on a single such computer system, or a collection of multiple such computer systems. The computer system 1100 can include a bus 1120 or other communication mechanism for communicating information, and a processor 1132 coupled to the bus 1120 for processing the information. The computer system 1100 can also include a memory 1134, such as a random access memory (RAM), other dynamic storage device (e.g., dynamic RAM (DRAM), static RAM (SRAM), synchronous DRAM (SDRAM), flash memory), etc., coupled to the bus 1120 for storing information and instructions to be executed by the processor 1132.

In addition, the memory 1134 can also be used for storing temporary variables or other intermediate information during the execution of instructions by the processor 1132. The computer system 1100 can further include a read only memory 1136 or other static storage device (e.g., programmable ROM (PROM), erasable PROM (EPROM), electrically erasable PROM (EEPROM), etc.) coupled to the bus 1120 for storing static information and instructions.

The computer system 1100 can also include a disk controller 1162 coupled to the bus 1120 to control one or more storage devices for storing information and instructions, such as a magnetic hard disk 1166, and a removable media drive 1164 (e.g., USB memory card drive, SD card drive, floppy disk drive, read-only compact disc drive, read/write compact disc drive, tape drive, and removable magneto-optical drive). The storage devices can be added to the computer system 1100 using an appropriate device interface (e.g., small computer system interface (SCSI), integrated device electronics (IDE), enhanced-IDE (EIDE), direct memory access (DMA), ultra-DMA), universal serial bus (USB), Firewire (IEEE 1394), or Bluetooth (IEEE 802.15.1).

The computer system 1100 can also include special purpose logic devices 1138, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, communications functions, etc.

The computer system 1100 also can include a display controller 1152 coupled to the bus 1120 to control a display 1154, such as a cathode ray tube (CRT), liquid crystal display (LCD), active matrix display, plasma display, touch display, etc., for displaying or conveying information to a computer user. The computer system can include input devices, such as a keyboard 1156 including alphanumeric and other keys and a pointing device 1158, for interacting with a computer user and providing information to the processor 1132. The pointing device 1158 can include, for example, a mouse, a trackball, a pointing stick, etc., or voice recognition processor, etc., for communicating direction information and command selections to the processor 1132 and for controlling cursor movement on the display 1154. In addition, a printer can provide printed listings of the data structures/information of the systems and methods of the present invention or any other data stored and/or generated by the computer system 1100.

The computer system 1100 can perform one or more processing steps of the invention in response to the processor 1132 executing one or more sequences of one or more instructions contained in a memory, such as the memory 1134. Such instructions can be read into the memory 1134 from another computer readable medium, such as the hard disk 1166 or the removable media drive 1164. Execution of the arrangement of instructions contained in the memory 1134 causes the processor 1132 to perform the process steps described herein. One or more processors in a multiprocessing arrangement also can be employed to execute the sequences of instructions contained in the main memory 1134. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 1100, for driving a device or devices for implementing the invention, and for enabling the computer system 1100 to interact with a human user (e.g., users of the systems and methods of the present invention, etc.). Such software can include, but is not limited to, device drivers, firmware, operating systems, development tools, applications software, etc. Such computer readable media can further include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 1100 also can include a communication interface 1170 coupled to the bus 1120. The communication interface 1170 can provide a two-way data communication coupling to a network link 1175 that is connected to a communications network such as, for example, a local area network (LAN), a wide area network (WAN), a global packet data communications network, such as the Internet, etc. For example, the communication interface 1170 can include a digital subscriber line (DSL) card or modem, a cable modem, a telephone modem, etc., to provide a data communication connection to a corresponding type of telephone line. As another example, the communication interface 1170 can include a local area network (LAN) card (e.g., for Ethernet, etc.), etc., to provide a data communication connection to a compatible LAN. Wireless links can also be implemented. In any such implementation, the communication interface 1170 can send and receive electrical, electromagnetic, or optical signals that carry digital data streams representing various types of information. Further, the communication interface 1170 can include peripheral interface devices, such as a Universal Serial Bus (USB) interface, a PCMCIA (Personal Computer Memory Card International Association) interface, etc.

The network link 1175 typically can provide data communication through one or more networks to other data devices. For example, the network link 1175 can provide a connection through the communications network 1110 to a server 1190. The communications network 1110 can employ electrical, electromagnetic, or optical signals to convey information and instructions. The signals through the various networks and the signals on the network link 1175 and through the communication interface 1170, which communicate digital data with computer system 1100, are exemplary forms of carrier waves bearing the information and instructions.

The computer system 1100 can send messages and receive data, including program code, through the communications network 1110, the network link 1175, and the communication interface 1170. In the Internet example, a server can transmit requested code belonging to an application program for implementing an embodiment of the present invention through communications network 1110 and the communication interface 1170. The processor 1132 can execute the transmitted code while being received and/or store the code in the storage devices 1164 or 1166, or other non-volatile storage for later execution. In this manner, computer system 1100 can obtain application code in the form of a carrier wave. With the system of FIG. 11, the embodiments of the present invention can be implemented on the Internet as a Web Server 1190 performing one or more of the processes according to the embodiments of the present invention for one or more computers coupled to the web server 1190 through the network 1110 coupled to the network link 1170.

The term “computer readable medium” as used herein can refer to any medium that participates in providing instructions to the processor 1132 for execution. Such a medium can take many forms, including but not limited to, non-volatile media, volatile media, transmission media, etc. Non-volatile media can include, for example, optical or magnetic disks, magneto-optical disks, etc., such as the hard disk 1166 or the removable media drive 1164. Volatile media can include dynamic memory, etc., such as the memory 1136. Transmission media can include coaxial cables, copper wire and fiber optics, including the wires that make up the bus 1120. Transmission media can also take the form of acoustic, optical, or electromagnetic waves, such as those generated during radio frequency (RF) and infrared (IR) data communications.

As stated above, the computer system 1100 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to communications network 1110. In such a scenario, the remote computer can load the instructions into memory and send the instructions, for example, over a telephone line using a modem. A modem of a local computer system can receive the data on the telephone line and use an infrared transmitter to convert the data to an infrared signal and transmit the infrared signal to a portable computing device, such as a personal digital assistant (PDA), a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

The above-described devices and subsystems of the illustrative embodiments can include, for example, any suitable servers, workstations, PCs, laptop computers, PDAs, Internet appliances, handheld devices, cellular telephones, wireless devices, other electronic devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (e.g., if processing is distributed) of the processing performed in implementing the illustrative embodiments. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, flash memories, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A computer implemented system for identifying an entity and characteristics thereof, the system comprising:
the system configured for identifying an entity and characteristics thereof, wherein the characteristics include as demographics, and psychographics behavior; and
the system configured for identifying the entity and the characteristics thereof based on patterns of social interactions and relations with other entities.

2. The system of claim 1, wherein the system is configured for determining and identifying an accurate description of the entity, the entity including a company, an organization, a place, a time slot event, a state, and a group; and
the system configured for the determining and the identifying based on analyzing entities connected to the entity including a social connection, a familial connection, sharing of an attribute or a relationship that can interpret a connection.

3. The system of claim 1, wherein the system is configured to extend a concept of DNA in a human body to social media and identifying the entity based on features and attributes defined by interaction of the entity with neighbors and friends.

4. The system of claim 1, wherein the system is configured to display and represent the entity with a colored bitmap.

5. A method for a computer implemented system for identifying an entity and characteristics thereof, the method comprising:
identifying with the system an entity and characteristics thereof, wherein the characteristics include as demographics, and psychographics behavior; and
identifying with the system the entity and the characteristics thereof based on patterns of social interactions and relations with other entities.

6. The method of claim 5, further comprising determining and identifying with the system an accurate description of the entity, the entity including a company, an organization, a place, a time slot event, a state, and a group; and
the determining and the identifying with the system based on analyzing entities connected to the entity including a social connection, a familial connection, sharing of an attribute or a relationship that can interpret a connection.

7. The method of claim 5, further comprising extending with the system a concept of DNA in a human body to social media and identifying the entity based on features and attributes defined by interaction of the entity with neighbors and friends.

8. The method of claim 5, further comprising displaying and representing with the system the entity with a colored bitmap.

9. A computer program product for a computer implemented system for identifying an entity and characteristics thereof, and including one or more computer readable instructions embedded on a non-transitory, tangible computer readable medium and configured to cause one or more computer processors to perform the steps of:
identifying with the system an entity and characteristics thereof, wherein the characteristics include as demographics, and psychographics behavior; and
identifying with the system the entity and the characteristics thereof based on patterns of social interactions and relations with other entities.

10. The computer program product of claim 5, further comprising determining and identifying with the system an accurate description of the entity, the entity including a company, an organization, a place, a time slot event, a state, and a group; and
the determining and the identifying with the system based on analyzing entities connected to the entity including a social connection, a familial connection, sharing of an attribute or a relationship that can interpret a connection.

11. The computer program product of claim 5, further comprising extending with the system a concept of DNA in a human body to social media and identifying the entity based on features and attributes defined by interaction of the entity with neighbors and friends.

12. The computer program product of claim 5, further comprising displaying and representing with the system the entity with a colored bitmap.
